(19) United States
(12) Patent Application Publication
(10) Pub. No.: US 2006/0250205 A1
(43) Pub. Date: Nov. 9, 2006

(54) Thermally conductive element for cooling an air gap inductor, air gap inductor including same and method of cooling an air gap inductor

(75) Inventors: Sukumar De, Ferns City (IN); Mark A. Thomson, Tottenham (CA); Manfred Vormbaum, Oakville (CA); Sunit Saxena, Mississauga (CA)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 11/121,552

(22) Filed: May 4, 2005

(51) Int. Cl. H01F 27/06

(52) U.S. Cl. 336/65

(57) ABSTRACT

An inductor including a magnetic core (30) including at least one magnetic core element (32), the magnetic core (30) having a first portion (38) spaced from and facing a second portion (42), at least one winding (36) supported by the magnetic core (30), and a thermally conductive element (10) having a thermal conductivity greater than about 100 w/mK in thermal contact with the first and second portions (38, 42), the electrically conductive element (10) defining a plurality of paths (26) from the first portion (38) to the second portion (42), the paths (26) being filled with an electrically insulative material (28). A method of cooling an inductor with a heat transfer device (10) is also disclosed.

### FIELD OF THE INVENTION

The present invention is directed to an improved cooling structure for an air gap inductor, an air gap inductor including same, and a method of cooling an air gap inductor, and, more specifically, toward a cooling structure for an air gap inductor adapted to conductively convey heat away from an inductor hot spot caused by flux fringing, an inductor including such a cooling element and to a method for dissipating heat caused by flux fringing.

### BACKGROUND OF THE INVENTION

Air gap inductors include a core formed from one or more core elements that are made from a magnetic material and often formed from a plurality of stacked laminations. These core elements support electric windings, which produce a magnetic flux in the core in a well known manner.

The core elements define one or more magnetic paths which include at least one air gap. The core includes at least one first face and at least one second face on opposite sides of the air gap, and the flux must flow through one face, across the air gap and through the second face as it travels around the core. A toroidal air gap inductor may comprise, for example, a single toroid with a segment removed to form a gap between first and second facing surfaces. In a C-core inductor, a first C-shaped core element facing a first direction faces a second, oppositely facing, C-shaped element. Two gaps are formed between the spaced legs of each “C.” An E-core inductor comprises first and second oppositely facing E-shaped elements with three gaps formed between corresponding legs of the elements.

The presence of an air gap in an inductor allows some magnetic flux to enter and exit the core at a position away from the faces on either side of the gap in a direction perpendicular to the plane of the core laminations. This so-called “flux fringing” generates eddy currents in the core elements which result in gap loss and the generation of additional heat, particularly at certain hot spots near the air gap where the flux reenters the core. To reduce the weight of an inductor, the inductor needs to be designed with high flux density and a relatively large air gap length. However, larger air gaps produce more flux fringing and thus a higher gap loss and more heating. This generation of excess heat makes it difficult to adequately cool the inductor. It therefore sometimes becomes necessary to provide either forced air or conductive cooling for the hotspot to maintain a desired inductor temperature.

Conductive cooling can be accomplished by placing a material having a high thermal conductivity, such as, for example, a metal like aluminum or copper, in or near the gap. However, materials with suitable thermal conductivities are often electrically conductive. Placing electrically conductive materials in the flux, however, leads to the formation of eddy currents therein and produces energy losses. It would therefore be desirable to provide a method and device for conducting heat generated by an inductor, especially heat generated by flux fringing near an air gap in an inductor, away from the inductor to the ambient air or a heatsink without generating significant energy losses.

### SUMMARY OF THE INVENTION

These and other problems are addressed by the present invention which comprises, in a first embodiment, an inductor including a magnetic core comprising at least one magnetic core element having a first portion spaced from and facing a second portion and at least one winding supported on the magnetic core. A thermally conductive element having a thermal conductivity greater than about 100 W/mK is placed in thermal contact with the first and second portions. The electrically conductive element defines a plurality of paths from the first portion to the second portion, the paths being filled with an electrically insulative material.

Another aspect of the invention comprises a method of cooling an inductor having at least one magnetic element and at least one gap between a first portion of the at least one magnetic element and a second portion of the at least one magnetic element. The method involves providing a thermally conductive element having a first side and a second side and a plurality of pathways from the first side to the second side and filling the plurality of pathways with a thermally conductive, electrically insulative material. Next, the element is inserted into the gap with the first side in thermal contact with the first portion and the second side in thermal contact with the second side. The thermally conductive element is placed in thermal contact with a heatsink. In this manner, heat generated in the at least one magnetic element is carried from the first and second portions to the heatsink by the thermally conductive element.

A further aspect of the invention comprises a heat transfer device for cooling an inductor having first and second portions separated by an air gap. The heat transfer device includes a metal sheet having first and second parallel ends and a plurality of folds extending between the first and second ends, ends, and an electrically insulative resin filling spaces between adjacent ones of the plurality of folds. The heat transfer device is mountable in the air gap with the first end in contact with the first portion and the second end in contact with the second portion for carrying heat away from the first and second ends to a heatsink.

### BRIEF DESCRIPTION OF THE DRAWINGS

These and other features and aspects of the invention will be better understood after a reading of the following detailed description together with the following drawings wherein:

FIG. 1 is perspective view of a heat transfer device according to an embodiment of the present invention;

FIG. 2 is a side elevational view of the heat transfer device of FIG. 1 with spaces between adjacent folds of the device filled with a curable material;

FIG. 3 is an exploded top plan view of an inductor core and a plurality of the heat transfer devices of FIG. 1;

FIG. 4 is perspective view of an inductor including heat transfer devices of FIG. 1;

FIG. 5 is a side elevational view of the inductor of FIG. 4 with one set of coils removed;

FIG. 6 is a perspective view of an inductor with a single heat transfer device according to the present invention arranged across multiple air gaps in the inductor;

FIG. 7 is a side elevational view of the inductor of FIG. 6 with one set of coils removed;

FIG. 8 is a side elevational view of a second embodiment of a heat transfer device according to the present invention;

FIG. 9 is a side elevational view of a third embodiment of a heat transfer device according to the present invention;

FIG. 10 is a side elevational view of a fourth embodiment of a heat transfer device according to the present invention;

FIG. 11 is a side elevational view of a first variation of the heat transfer device of FIG. 10;

FIG. 12 is a side elevational view of a second variation of the heat transfer device of FIG. 10;

FIG. 13 is a side elevational view of a fifth embodiment of a heat transfer device according to the present invention; and

FIG. 14 is a flow chart illustrating a method of cooling an inductor according to an embodiment of the present invention.

### DETAILED DESCRIPTION

Referring now to the drawings, wherein the showings are for the purpose of illustrating preferred embodiments of the present invention only, and not for the purpose of limiting same, FIG. 1 illustrates a heat transfer device 10 having a first side 12, a second side 14, a top 16 and a bottom 18. The distance from first side 12 to second side 14 may be referred to herein as the depth of heat transfer device 10; the distance from top 16 to bottom 18 may be referred to as the height of the heat transfer device 10.

Heat transfer device 10 is formed from a sheet of material repeatedly folded back on itself to form a series of folds 20 (or molded or cast in such a form) each fold 20 comprising a pair of primary walls 22 extending from first side 12 to second side 14 and from top 16 to bottom 18 of device 10 and a single connecting wall 24 connecting adjacent ones of primary walls 22. Device 10 is formed so that, looking in the direction from first side 12 to second side 14, it has the appearance of a square wave having an amplitude significantly greater than its wavelength. Device 10 could be formed with the shape of a different waveform, such as that of a sine wave, without exceeding the scope of this invention. First side 12 will generally lie substantially completely in a first plane and second side 14 will generally lie substantially completely in a second plane approximately parallel to the first plane. Likewise, top 16 will generally lie in a third plane and bottom 16 will lie generally in a fourth plane approximately parallel to the third plane. However, it is also envisioned that some portions of device 10 may project beyond the fourth plane for reasons discussed hereafter.

Heat transfer device 10 is formed from a material having a high thermal conductivity, preferably a thermal conductivity above about 100 W/mK, more preferably, above about 200 W/mK, and most preferably about above about 300 W/mK over an operating temperature range of about 40° C. to 200° C. Aluminum is an inexpensive and readily available material having a thermal conductivity above 200 W/mK at room temperature and above. Copper has a higher thermal conductivity, above 300 W/mK at room temperature above. The choice between copper and aluminum depends in part on whether the additional cooling provided by copper is worth the additional cost. Aluminum alloy 1100-H14 is presently preferred for forming the heat transfer device 10.

Materials such as copper and aluminum having suitably high thermal conductivities are also electrically conductive. As such, eddy currents will be generated in an aluminum or copper object placed in a magnetic flux. To reduce the generation of eddy currents in an aluminum or copper heat transfer device 10, and thus keep energy loss at an acceptably low level, heat transfer device 10 is formed from a thin sheet of material having a thickness of less than about 0.003 inches. Primary walls 22 and connecting walls 24 are also arranged so they will be parallel to the direction of magnetic flux, that is, normal to the first plane of first side 12 and to the second plane of second side 14, when device 10 is placed in the air gap.

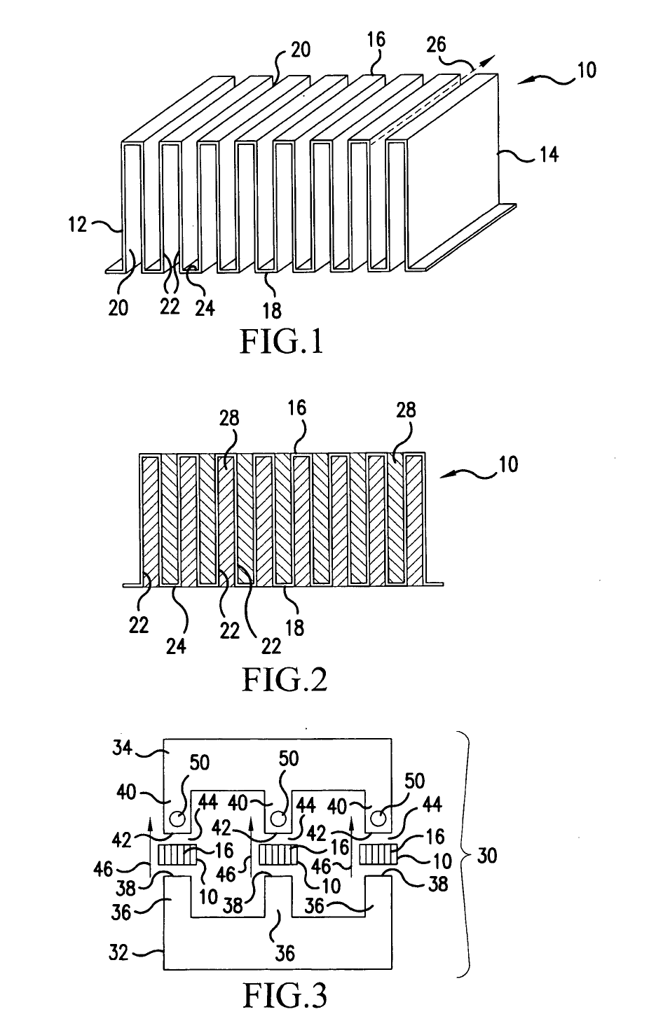

Primary walls 22 define a plurality of paths 26 between first side 12 and second side 14 through which magnetic flux flows without passing through an electrically conductive material when device 10 is placed in the air gap of an inductor. These paths may contain only air, but more preferably are filled with a curable material 28, illustrated in FIG. 2, such as an epoxy resin, that is electrically insulating but that has a relatively high thermal conductivity. The viscosity of the selected material should also be low enough to allow it to readily penetrate and fill the spaces between primary walls 22. A presently preferred material is a two-component epoxy resin available from Master Bond, Inc. of Hackensack, N.J. under the part number EP37-3FLFAN. This material has a thermal conductivity of about 3.6 W/mK, an electrical resistivity of 10¹⁴ cm, and a viscosity of 60,000 to 80,000 cps.

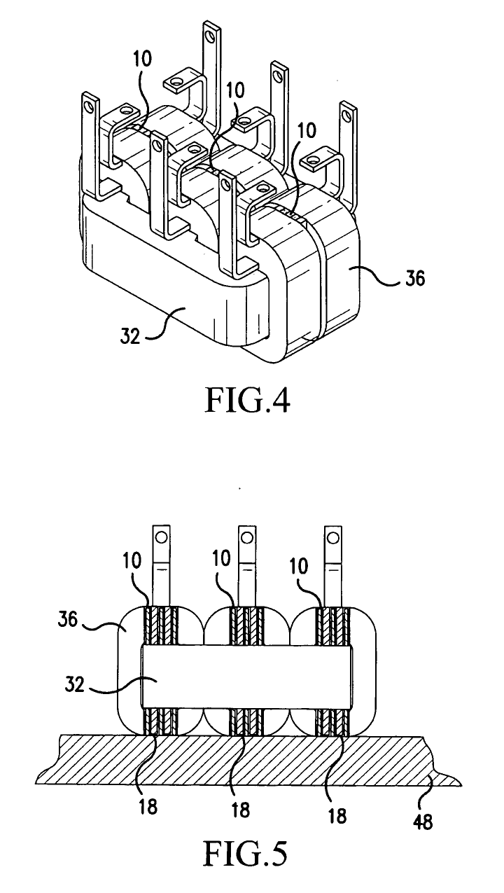

FIGS. 3-5 illustrate an E-frame inductor comprising a core 30 formed of a first core element 32 and a second core element 34 and a plurality of windings 36 supported by core 30. First core element 32 includes three legs 36 each of which terminates at a first surface 38; second core element 34 includes three legs 40 each of which terminates at a second surface 42. The spacing between first surfaces 38 and second surfaces 42 defines the air gap 44 of the inductor across which flux induced by windings 36 normally travels. Arrows 46 in FIG. 3 indicate the direction of flux flow from first core element 32 across air gap 44 to second core element 34.

As illustrated in FIGS. 3-5, three heat transfer devices 10 according to an embodiment of the present invention are mounted in the air gaps 44 between the legs 36 of first core element 32 and the legs 40 of second core element 34. First sides 12 of each heat transfer device 10 are in thermal contact with first surfaces 38 of first core element 32 and second sides 14 of the heat transfer devices 10 are in thermal contact with second surfaces 42 of second core element 34. The bottom 18 of each heat transfer element is in thermal contact with a heatsink 48 and may, in some cases, project beyond windings 36 to ensure good thermal contact between heat transfer device 10 and heatsink 48.

With reference to FIG. 3, most of the magnetic flux traveling through core 30 will exit first surfaces 38 of first legs 36 and reenter second core element 34 at second surfaces 42 of legs 40. However, as is well known in the art, whenever an air gap is present between two core elements, some flux will not follow this direct path, but rather, will bend away from first core element 32 and reenter second core element 34 at a location away from second surface 42, at location 50, for example. This is sometimes referred to as “flux fringing.” These locations 50 are sometimes referred to as “hot spots” because the reentry of the flux in a direction normal to the laminations of the core elements generates eddy currents and heat. Heat transfer devices 10, however, are located relatively close to these hot spots 50 and thus effectively conduct heat away from the hot spots 50 to heatsink 48, thereby cooling core 30.

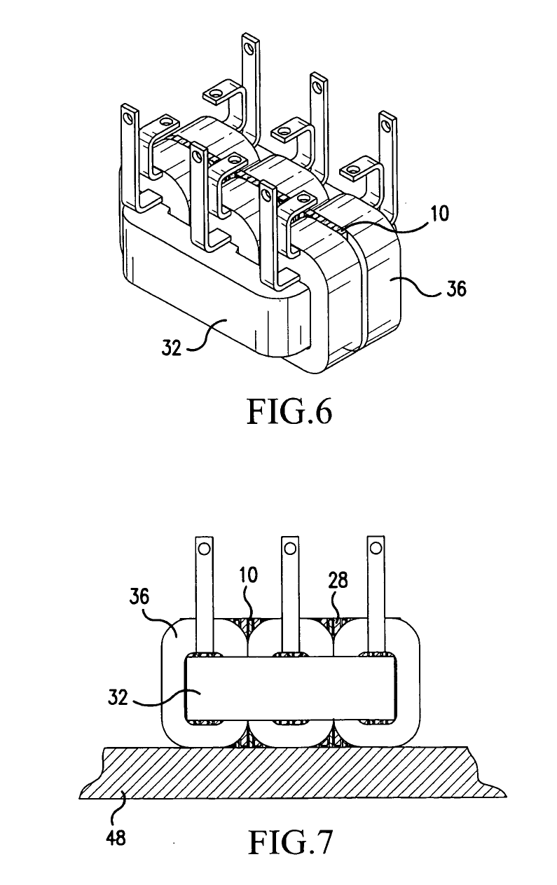

A variation of heat transfer device 10 is illustrated in FIGS. 6 and 7. In this variation, heat transfer device 10 is large enough to span all air gaps 44 between the three pairs of legs of inductor 30. This arrangement increases both the amount of metal available to carry heat, but also adds to the amount of metal in which eddy currents may be generated. Which variation is selected will depend on the particular application for which the inductor is used and the magnitude of the flux flowing therethrough.

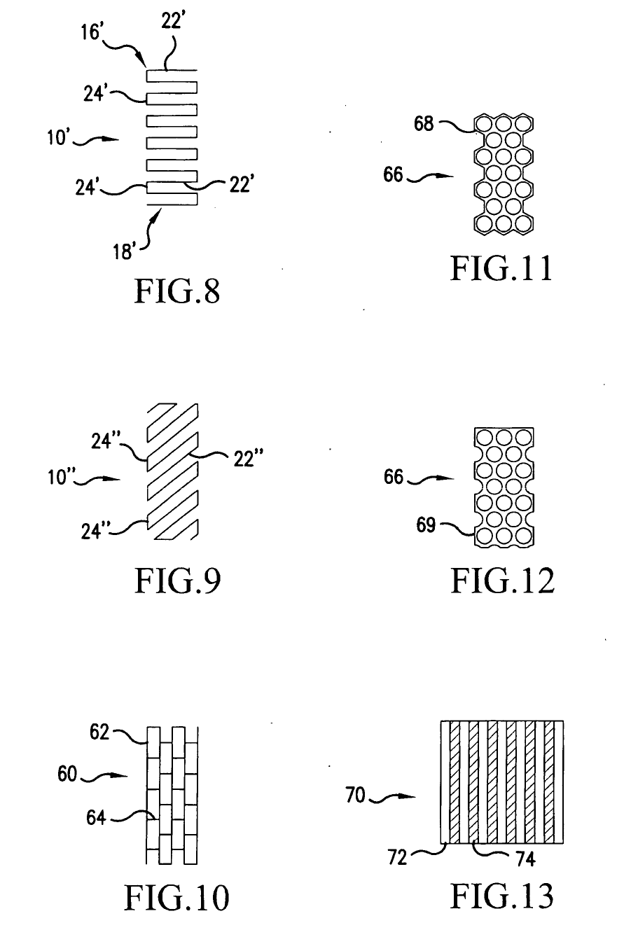

In FIGS. 1-7, heat transfer device 10 includes a plurality of primary walls extending between top 16 and bottom 20 of the heat transfer device 10 and a plurality of connecting walls 24 parallel to the plane of the top 16 of the heat transfer device. However, alternate structures can be used as heat transfer devices as illustrated in FIGS. 8-13.

FIG. 8 illustrates a second embodiment of a heat transfer device 10′. In this embodiment, elements that correspond to elements of the first embodiment are designated using the same reference numeral and a prime. Heat transfer device 10′ includes primary walls 22′ extending in the plane of heat transfer device top 16′ and connecting walls 24′ extending between top 16′ and bottom 18′ of heat transfer device 10. Primary walls 22′ and connecting walls 24′ are arranged so that they will extend parallel to the direction of flux flow when heat transfer device 10′ is placed into the air gap of an inductor.

FIG. 9 illustrates a third embodiment of a heat transfer device 10″. In this embodiment, elements that correspond to elements of the first embodiment are designated with the same reference numeral and a double prime. In this embodiment, connecting walls 24″ extend in the direction of top 16″ to bottom 18″ and primary walls 22″ extend at an angle, such as about 45 degrees, to the plane of the top and bottom of heat transfer device 10″.

FIG. 10 illustrates a fourth embodiment of a heat transfer device 60 in which flux flow paths 26 are defined by a rectangular lattice of first walls 62 and second walls 64. These walls define pathways having a cross section that is a closed curve—a rectangle in this embodiment, as opposed to the first embodiment wherein the pathways 26 had a cross section that was an open curve. This arrangement provides for additional metal to improve heat conduction; however, the additional metal also will produce lead to greater losses from eddy currents. This design also simplifies the process of filling gaps between the first walls 62 and second walls 64 with a curable material because second walls 64 will help retain the curable material in the heat transfer device while it cures.

FIG. 11 illustrates a first variation of the heat transfer device 60 discussed above; in this embodiment, a hexagonal lattice of walls 66 is provided defining paths 26 having hexagonal cross sections through the heat transfer device 60. FIG. 12 illustrates a second variation of the heat transfer device 60 in which circular paths defined by walls 69 are provided.

FIG. 13 illustrates a fifth embodiment of the present invention wherein a heat transfer device 70 comprises a plurality of plates 72 held together by curable resin 74. Plates 72 correspond generally to the primary walls 22 of the first embodiment; however, in this embodiment, no connecting walls are present and the curable resin 74 holds the heat transfer device together. This arrangement thus may provide good heat transfer characteristics while reducing the amount of metal used.

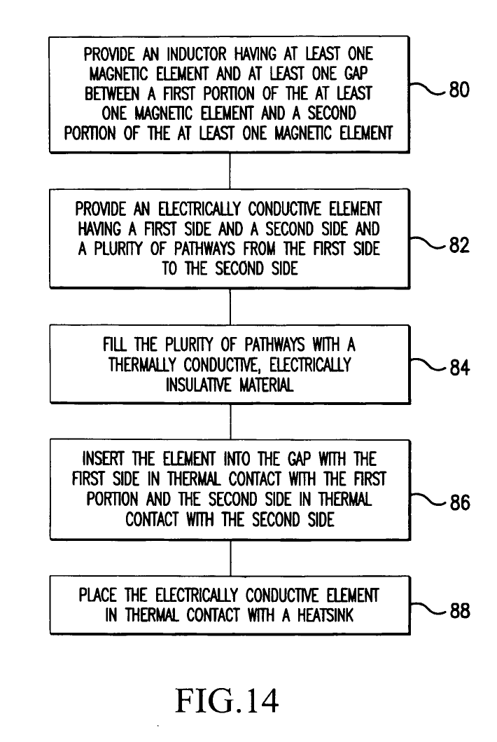

A method according to an embodiment of the present invention is illustrated in FIG. 14 which method includes a step 80 of providing an inductor having at least one magnetic element and at least one gap between a first portion of the at least one magnetic element and a second portion of the at least one magnetic element, a step 82 of providing an electrically conductive element having a first side and a second side and a plurality of pathways from the first side to the second side, a step 84 of filling the plurality of pathways with a thermally conductive, electrically insulative material, a step 86 of inserting the element into the gap with the first side in thermal contact with the first portion and the second side in thermal contact with the second side and a step 88 of placing the electrically conductive element in thermal contact with a heatsink.

The invention has been described herein in terms of several embodiments. Obvious modifications and additions to these embodiments will become apparent to those skilled in the relevant arts upon a reading of the foregoing description. It is intended that all such obvious variations and additions form a part of the present invention to the extend that they fall within the scope of the several claims appended hereto.

We claim:

1. An inductor including:
a magnetic core comprising at least one magnetic core element, said magnetic core having a first portion spaced from and facing a second portion;
at least one winding supported by said magnetic core; and
a thermally conductive element having a thermal conductivity greater than about 100 w/mK in thermal contact with said first and second portions, said electrically conductive element defining a plurality of paths from said first portion to said second portion, said paths being filled with an electrically insulative material.

2. The inductor of claim 1 wherein said thermally conductive element is electrically conductive.

3. The inductor of claim 2 wherein said electrically conductive element is selected from the group consisting of copper and aluminum.

4. The inductor of claim 2 wherein at least some of the plurality of paths have a cross section comprising a closed curve.

5. The inductor of claim 4 wherein said closed curve is selected from the group consisting of a rectangle, a hexagon and a circle.

6. The inductor of claim 2 wherein said at least some of said paths have a cross section comprising an open curve.

7. The inductor of claim 2 wherein said thermally conductive element comprises a sheet of-material having a plurality of folds, said paths being defined by adjacent portions of said folds.

8. The inductor of claim 2 wherein said thermally conductive element comprises a plurality of thermally conductive strips mutually joined by electrically insulative material.

9. The inductor of claim 1 wherein said electrically insulative material comprises a curable material.

10. The inductor of claim 9 wherein said curable material comprises a curable resin.

11. The inductor of claim 9 wherein said curable material comprises an epoxy resin.

12. The inductor of claim 1 wherein said thermally conductive element includes at least one portion projecting beyond the at least one winding.

13. The inductor of claim 1 wherein said at least one magnetic core element comprises first and second spaced magnetic core elements, wherein said first portion is located on said first magnetic core element and said second portion is located on said second magnetic core element, said first magnetic core element including a third portion spaced from a fourth portion on said second magnetic core element, wherein said thermally conductive element thermally connects said first, second, third and fourth portions.

14. The inductor of claim 1 wherein said thermally conductive element has a thickness of less than or equal to about 0.003 inches.

15. A method of cooling an inductor having at least one magnetic element and at least one gap between a first portion of the at least one magnetic element and a second portion of the at least one magnetic element, comprising the steps of:
providing an thermally conductive element having a first side and a second side and a plurality of pathways from the first side to the second side;
filling the plurality of pathways with a thermally conductive, electrically insulative material;
inserting the element into the gap with the first side in thermal contact with the first portion and the second side in thermal contact with the second side; and
placing the thermally conductive element in thermal contact with a heatsink,
whereby heat generated in the at least one magnetic element is carried from the first and second portions to the heatsink by the thermally conductive element.

16. The method of claim 15 wherein said step of filling the plurality of pathways with a thermally conductive, electrically insulative material comprises the steps of pouring a liquid resin into the plurality of pathways and allowing the resin to cure.

17. A heat transfer device for cooling an inductor having first and second portions separated by an air gap comprising:
a metal sheet having first and second parallel ends and a plurality of folds extending between said first and second ends, ends; and
an electrically insulative resin filling spaces between adjacent ones of said plurality of folds;
whereby said heat transfer device is mountable in the air gap with said first end in contact with said first portion and said second end in contact with said second portion for carrying heat away from said first and second ends to a heatsink.

18. The heat transfer device of claim 17 wherein said metal sheet has a thickness of less than or equal to about 0.003 inches.
